(19) United States
(12) Patent Application Publication
(10) Pub. No.: US 2025/0362472 A1
(43) Pub. Date: Nov. 27, 2025

(54) FINE ADJUSTMENT SYSTEM FOR OPTICS COMPONENTS

(71) Applicant: Photon Valley, Inc., Lake Forest, CA (US)

(72) Inventors: James Campbell, Foothill Ranch, CA (US); Harit Kaushikbhai Patel, Lake Forest, CA (US); Pamela Nola, Huntington Beach, CA (US)

(21) Appl. No.: 18/670,548

(22) Filed: May 21, 2024

(51) Int. Cl. G02B 7/02; G02B 7/182

(52) U.S. Cl. CPC G02B 7/023; G02B 7/026; G02B 7/182; G02B 7/028

(57) ABSTRACT

Systems that enable fine adjustment of the orientation of optics components housed in those systems. Systems include an adjusting body, a mounting ring, and a set of coil springs pulling those two together. Three adjustment pillars interact with the adjusting body such that rotation or manipulation of any of the adjustment pillars brings about reorientation of the adjusting body. Adjustment pillars contact the mounting ring in radially oriented grooves to prevent thermal expansion or contraction from negatively affecting adjusting body orientation and to facilitate smooth reorientation of the adjusting body during normal operation.

### FIELD OF THE INVENTION

The field of the invention is adjustment systems and mechanisms for optics components.

### BACKGROUND

The background description includes information that may be useful in understanding the present invention. It is not an admission that any of the information provided in this application is prior art or relevant to the presently claimed invention, or that any publication specifically or implicitly referenced is prior art.

Mounts and adjustment systems for use with optics and optical components (and in related fields) are often impacted by thermal expansion or contraction. For example, when a device holding an optical component such as a mirror or lens is subject to thermal expansion, its alignment and orientation can be negatively impacted, causing misalignment. These misalignments arise during use or testing of different optical prototyping setups, giving rise to a need for fine adjusting to account for thermal expansion. This creates additional work and, in some situations, can render an optical setup ineffective with multiple components all becoming misaligned during use when heat affects all those components.

There is therefore a need in the art for a devices that can hold optical components and whose alignments and orientations are unaffected by thermal expansion.

### SUMMARY OF THE INVENTION

The present invention provides apparatuses and systems directed to fine adjustors that can be used in association with kinematic mounts for optical components. In one aspect of the inventive subject matter, a fine adjustor for optical components comprises: a mounting ring comprising a set of adjustor grooves; an adjusting body comprising a set of adjustment pillars, where each adjustment pillar of the set comprises a contact end, and wherein each contact end rests within an adjustor groove of the set of adjustor grooves; and a set of coil springs coupled with the mounting ring and with the adjusting body.

In some embodiments, each adjustment pillar of the set of adjustment pillars is threaded. The contact end of each adjustment pillar can include a ball bearing to reduce friction. In some embodiments, the adjustor grooves all extend radially outward. Some embodiments also include a set of pegs affixed to the mounting ring, where the pegs make it easier to handle the device without affecting the orientation of the adjusting body. In some embodiments, the adjusting body has a hardware mounting space and a retaining ring disposed therein.

In another aspect of the inventive subject matter, a fine adjustor for optical components comprises: a mounting body comprising a set of radially aligned adjustor grooves; an adjusting body comprising a set of adjustment pillars; wherein each adjustment pillar passes through the adjusting body and contacts a radially aligned adjustor groove; and a set of coil springs coupled with the mounting body and with the adjusting body.

In some embodiments, the fine adjustor also includes a set of top retaining bars and a set of bottom retaining bars, where each coil spring couples with a top retaining bar and a bottom retaining bar. And in some embodiments, the adjusting body include through holes to accommodate each coil spring of the set of coil springs. In some embodiments the adjusting body has a hardware mounting space and a retaining ring disposed therein. There can also be a set of pegs affixed to the mounting body, and each adjustor groove can be oriented to extend radially outward. Each adjustment pillar can also include a ball bearing to reduce friction where each pillar contacts a groove.

In another aspect of the inventive subject matter, a fine adjustor for optical components comprises: a mounting body comprising a set of adjustor grooves; an adjusting body comprising a set of adjustment pillars; and where each adjustment pillar couples with the adjusting body and contacts an adjustor groove on the mounting body.

In some embodiments, the fine adjustor also include a set of coil springs coupled with the mounting body and with the adjusting body. The fine adjustor can also include a set of top retaining bars and a set of bottom retaining bars, where each coil spring couples with a top retaining bar and a bottom retaining bar. The adjusting body can include a hardware mounting space and a retaining ring disposed therein. In some embodiments, the fine adjustor has a set of pegs affixed to the mounting body. Each adjustor groove can also be oriented to extend radially outward, and each adjustment pillar can include a ball bearing at its tip to reduce friction with the grooves.

One should appreciate that the disclosed subject matter provides many advantageous technical effects including creating a device to make fine adjustments to the orientation of optical components where the orientation of that device is unaffected by thermal expansion.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a front, angled view of a fine adjustor.

FIG. 2 is a front, angled view of a fine adjustor with the adjusting body hidden.

FIG. 3 is a bottom, angled view of a fine adjustor with the mounting ring hidden.

FIG. 4 is a bottom view of a fine adjustor.

FIG. 5 shows another embodiment of a mounting ring.

FIG. 6 shows a fine adjustor mounted within a kinematic mount.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Embodiments of the inventive subject matter are directed to fine adjustors that can be used with optical equipment and optics components such as mirrors, lenses, lasers, and the like. In developing optical setups to conduct a wide variety of experiments, optical equipment is often arranged on a breadboard. Once prototyped on a breadboards, adjustments must be made, both course and fine, to achieve a desired functionality. Such setups commonly include components like lasers, mirrors, slits, collimators, lenses, optics mounts, and so on.

In developing prototype setups using breadboards and various components to secure and adjust optical equipment and optics components, many manual adjustments must be made. For example, to ensure a laser is reflected from a mirror to a desired location (e.g., another optical component), the mirror's orientation must be adjustable. To facilitate manual adjustments and reorientations, kinematic mounts are described in U.S. Pat. No. 11,347,025. That patent is incorporated to this application by reference. Embodiments of the inventive subject matter are designed for use primarily with the kinematic mounts described in that patent.

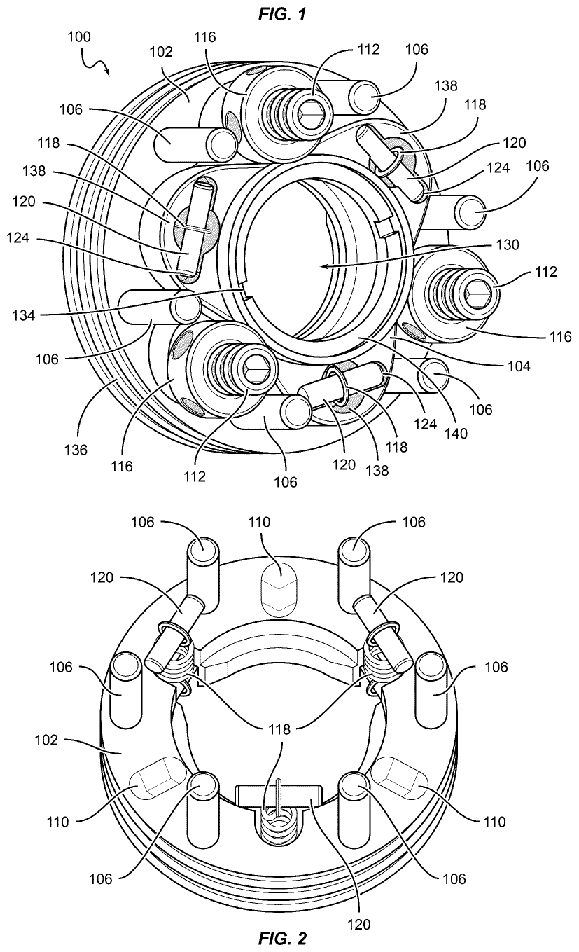

FIG. 1 shows a front, angled view of fine adjustor 100. Fine adjustor 100 includes a mounting ring 102 and an adjusting body 104. Mounting ring 102 is shown in more detail in FIG. 2. Mounting ring 102 comprises a set of pegs 106 that protrude from its top surface 108, where top surface 108 is the surface that faces adjusting body 104. Pegs 106 extend from mounting ring 102 and are firmly affixed thereto. Pegs 106 are long enough to extend past adjusting body 104 and are included to facilitate manipulation and handling of fine adjustor 100 so that it can be placed and positioned in other hardware like kinematic mounts. Pegs 106 therefore give a user a set of firm objects to press against to avoid pressing against adjusting body 104 or its associated hardware components, which are more sensitive and liable to break or misalign adjusting body 104 relative to mounting ring 102 when pressed against.

Adjusting body 104 features hardware mounting space 130. Hardware mounting space 130 is shown having a circular cross section, though having a circular cross section is not necessary. Hardware mounting space 130 features a retaining lip 132 at a bottom portion, where retaining lip 132 forms a smaller opening than the opening of hardware mounting space 130. In some embodiments, retaining lip 132 is a circular intrusion into hardware mounting space 130, though retaining lip 132 can take other shapes and forms without deviating from the inventive subject matter. It is important for retaining lip 132 to prevent, e.g., a properly sized optical component from passing completely through hardware mounting space 130.

Hardware mounting space 130 creates space for retaining ring 140 to rest within it. Retaining ring 140 features two notches 134. Notches 134 are disposed on opposite sides of hardware mounting space 130, and notches 134 are included to make it easier to grab, remove, or place optics components that are placed in hardware mounting space 130. For example, once a disk-shaped mirror is placed in hardware mounting space 130, it may be difficult to remove without turning the entire adjusting body upside down to leverage gravity. Notches 134 instead offer a way for a tool to grab an optical component by applying pressure to opposite sides of the component so that it can be removed from hardware mounting space 130.

Front surface includes three adjustor grooves 110. In some embodiments, these grooves can be formed by raised material instead of by areas of removed material. Adjustor grooves 110 are all oriented to align with lines extending radially outward from the center of mounting ring 102. Adjustor grooves 110 are elongated and designed as guides for adjustment pillars 112. Adjustor grooves 110 are elongated for several reasons, including to make it possible for adjusting body 104 to reorient relative to mounting ring 102 and to allow for thermal expansion and contraction without affecting orientation of adjusting body 104. A major issue that existing mounts experience is that thermal expansion (e.g., resulting from an optical component being a target for a laser) causes changes to optic orientation. This results from most optical adjusting and mounting components being asymmetrically designed. These asymmetries can negatively impact alignment and force fine adjustments to be made during use. But because adjustor grooves 110 are radially aligned, thermal expansion and contraction can occur without impacting overall orientation of adjusting body 104 (or an optical component held therein).

In addition to making adjusting body 104 able to handle thermal expansion and contraction without affecting its overall orientation, radially aligned adjustor grooves 110 are also needed to allow adjusting body 104 to change orientations smoothly. Because adjusting body 104 is mounted by three adjustment pillars 112, extending any one adjustment pillar causes a change in orientation of adjusting body 104, while also changing distances between each of the pillars relative to the pillar that is adjusted (as measured from the points at which the pillars contact the grooves). Adjustment pillars 112 are shown having hex compatible heads to facilitate tool-assisted rotation.

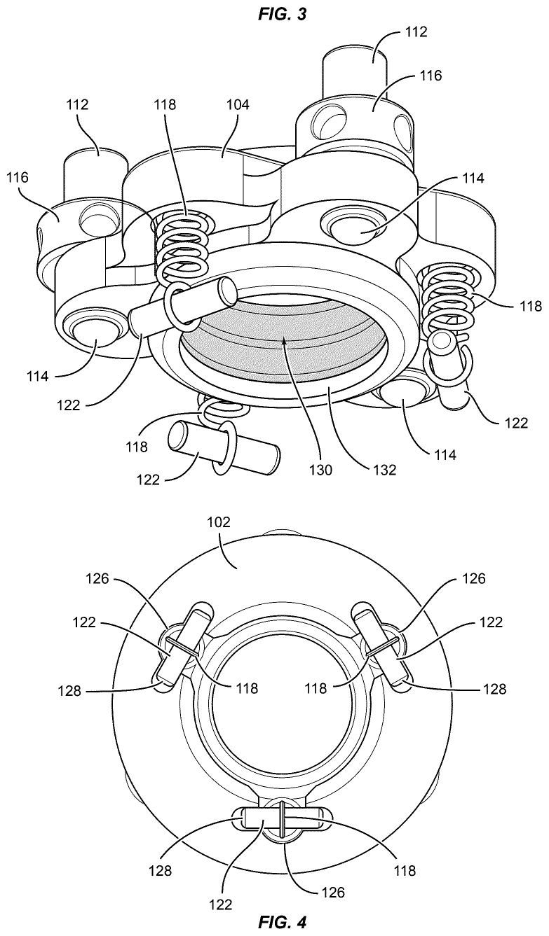

Adjustment pillars 112 each comprise ends that fit into adjustor grooves 110. FIG. 3 shows a bottom view of adjusting body 104 with adjustment pillars 112 extending therethrough with mounting ring 102 hidden. From this view, contact ends 114 of adjustment pillars 112 are visible. Contact ends 114 feature ball bearings to minimize friction between contact ends 114 and grooves 110. In some embodiments, contact ends 114 are rounded but without ball bearings.

Adjustment pillars 112 are threaded, and mate with similarly threaded holes in adjusting body 104. Thus, turning an adjustment pillar 112 causes it to move relative to adjusting body 104. As shown in FIG. 1, each adjustment pillar 112 features a lock nut 116. Thus, to change adjusting body's orientation, one or more adjustment pillars 112 are turned, which causes the affected adjustment pillar to move relative to adjusting body 104. Once an adjustment pillar 112 is in a new position, it can be locked into place using a lock nut 116. Lock nuts 116 have threaded interiors that match the exterior threads of adjustment pillars 112 so that lock nuts 116 can be screwed onto adjustment pillars 112. By tightening lock nuts 116 against adjusting body 104, adjustment pillars 112 are locked into place. Locking in this way does not affect adjustment pillar position and thus does not affect an orientation of adjusting body 104.

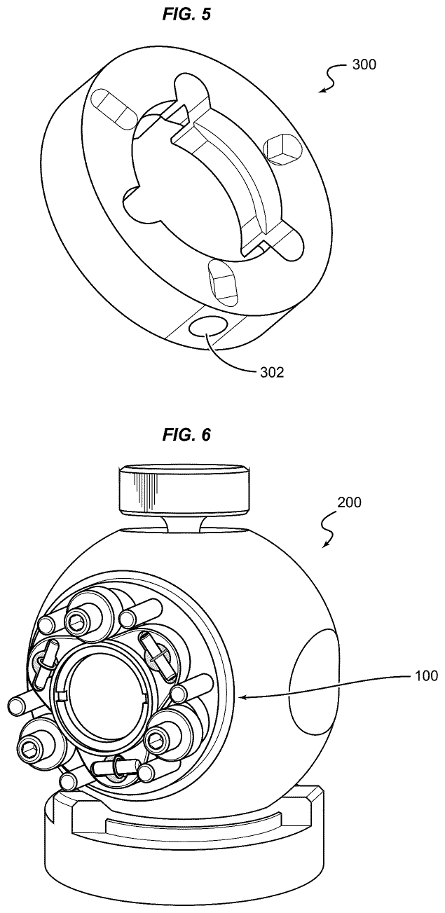

Also shown in FIG. 1 are circumferential grooves 136 (alternatively, slots or threads) that are disposed on the outside edge of adjusting body 104. Grooves 136 can be used to, e.g., interact with a set screw on a kinematic mount that fine adjustor 100 is placed into, while in embodiments where grooves 136 are threads, they can be used to screw fine adjustor 100 into place where the, e.g., kinematic mount that it is coupled with has complementary threading to receive fine adjustor 100. An alternative mounting ring 300 embodiment is shown in FIG. 5 having a threaded hole 302 on a side that a set screw can be inserted into to couple mounting ring 300 with a kinematic mount that it is placed in.

FIG. 2 also shows tensioning mechanisms that each comprise a coil spring 118, a top retaining bar 120 and a bottom retaining bar 122. Bottom retaining bars 122 are more easily visible in FIGS. 3 and 4. Top retaining bars 120, as shown in FIG. 1, nest into top retaining bar grooves 124. Top retaining bar grooves 124 are sized and dimensioned according to the sizes and dimensions of top retaining bars 120, such that top retaining bars 120 do not move out of place when they are pulled by coil springs 118. Top retaining bar grooves 124 each additionally feature a top widened middle portion 138. Top widened middle portions 138 align with through holes in adjusting body 104 that accommodate coil springs 118 so that coil springs 118 can pass through adjusting body 104 to pull down on top retaining bars 120.

FIG. 4 shows a bottom view of mounting ring 102. From this view, bottom retaining bars 122 and bottom retaining bar grooves 128 are visible. Coil springs 118 are thus in tension between top retaining bars 120 and bottom retaining bars 122, such that adjusting body 104 is constantly being pulled toward mounting ring 102. This results in adjustment pillars 112 being held such that their contact ends 114 are pressed into adjustor grooves 110, which in turn makes it so when any of adjustment pillars 112 is rotated, adjusting body's orientation relative to mounting ring 102 is affected.

Bottom retaining bar grooves 128, like top retaining bar grooves 124, feature bottom widened middle portions 126. Bottom widened middle portions 126 serve the same purpose as top widened middle portions 138—they create space for coil springs 118 to couple with bottom retaining bars 122 after passing through mounting ring 102. With bottom retaining bars 122 are disposed on a bottom side of mounting ring 102 and top retaining bars 120 are disposed on a top side of adjusting body 104, coil springs 118 are configured to always remain in tension to pull adjusting body 104 toward mounting ring 102.

FIG. 3 shows a view of fine adjustor 100 with mounting ring 102 hidden. This view shows coil springs 118 extending through holes in adjusting body 104 (where coil springs 118 couple with top retaining bars 120 after passing through the holes in adjusting body 104). This view also shows bottom retaining bars 122 and how they couple with coil springs 118. Hardware mounting space 130 is also visible from this perspective, showing retaining lip 132 from the bottom side.

FIG. 6 shows fine adjustor 100 disposed within a kinematic mount 200. Kinematic mount 200 is configured to facilitate rough adjustments, while fine adjustor 100 is configured to make fine adjustments to bring an optical component into a final desired orientation.

Thus, specific apparatuses and systems directed to fine adjustment mechanisms for use in kinematic optical mounts have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A fine adjustor for optical components, comprising:
a mounting ring comprising a set of adjustor grooves;
an adjusting body comprising a set of adjustment pillars;
wherein each adjustment pillar of the set comprises a contact end, and wherein each contact end rests within an adjustor groove of the set of adjustor grooves; and
a set of coil springs coupled with the mounting ring and with the adjusting body.

2. The fine adjustor of claim 1, wherein each adjustment pillar of the set of adjustment pillars is threaded.

3. The fine adjustor of claim 1, wherein the contact end of each adjustment pillar comprises a ball bearing.

4. The fine adjustor of claim 1, wherein each adjustor groove of the set of adjustor grooves extends radially outward.

5. The fine adjustor of claim 1, further comprising a set of pegs affixed to the mounting ring.

6. The fine adjustor of claim 1, wherein the adjusting body comprises a hardware mounting space and a retaining lip.

7. A fine adjustor for optical components, comprising:
a mounting body comprising a set of radially aligned adjustor grooves;
an adjusting body comprising a set of adjustment pillars;
wherein each adjustment pillar passes through the adjusting body and contacts a radially aligned adjustor groove; and
a set of coil springs coupled with the mounting body and with the adjusting body.

8. The fine adjustor of claim 7, further comprising a set of top retaining bars and a set of bottom retaining bars, wherein each coil spring couples with a top retaining bar and a bottom retaining bar.

9. The fine adjustor of claim 7, wherein the adjusting body comprises through holes to accommodate each coil spring of the set of coil springs.

10. The fine adjustor of claim 7, wherein the adjusting body comprises a hardware mounting space and a retaining lip.

11. The fine adjustor of claim 7, further comprising a set of pegs affixed to the mounting body.

12. The fine adjustor of claim 7, wherein each adjustor groove of the set of adjustor grooves extends radially outward.

13. The fine adjustor of claim 7, wherein each adjustment pillar comprises a ball bearing.

14. A fine adjustor for optical components, comprising:
a mounting body comprising a set of adjustor grooves;
an adjusting body comprising a set of adjustment pillars; and
wherein each adjustment pillar couples with the adjusting body and contacts an adjustor groove on the mounting body.

15. The fine adjustor of claim 14, further comprising a set of coil springs coupled with the mounting body and with the adjusting body.

16. The fine adjustor of claim 15, further comprising a set of top retaining bars and a set of bottom retaining bars, wherein each coil spring couples with a top retaining bar and a bottom retaining bar.

17. The fine adjustor of claim 14, wherein the adjusting body comprises a hardware mounting space and a retaining lip.

18. The fine adjustor of claim 14, further comprising a set of pegs affixed to the mounting body.

19. The fine adjustor of claim 14, wherein each adjustor groove of the set of adjustor grooves extends radially outward.

20. The fine adjustor of claim 14, wherein each adjustment pillar comprises a ball bearing.
